(19) United States
(12) Patent Application Publication
(10) Pub. No.: US 2018/0145780 A1
(43) Pub. Date: May 24, 2018

(54) ONLINE PREDICTION OF CLOCK OFFSETS BETWEEN NETWORKED MACHINES

(71) Applicant: Microsoft Technology Licensing, LLC, Redmond, WA (US)

(72) Inventors: Weidong Zhao, Bellevue, WA (US); Jayashree Sadagopan, Bellevue, WA (US)

(73) Assignee: Microsoft Technology Licensing, LLC, Redmond, WA (US)

(21) Appl. No.: 15/357,764

(22) Filed: Nov. 21, 2016

(51) Int. Cl. H04J 3/06

(52) U.S. Cl. CPC H04J 3/0661; H04J 3/0682

(57) ABSTRACT

Technologies are described for determining clock offsets between computing devices. Clock offsets between the computing devices are determined based on timestamp information associated with forward packets and reverse packets sent between the computing devices. For example, a forward series and a reverse series of timestamp points can be obtained from forward and reverse network packets. A forward anchor series and a reverse anchor series can be generated from the forward series and the reverse series. The clock offset between the computing devices can be estimated using the forward anchor series and the reverse anchor series.

### BACKGROUND

It is important for computing devices to have reliable and accurate timing systems that can be used locally and between computing devices. In some network environments, clock synchronization is provided by a remote service (e.g., accessible via the Internet). However, in situations where computing devices do not have access to, or otherwise cannot utilize, a remote clock synchronization service, it may be difficult to maintain clock synchronization between devices or be able to reliably determine if there is a clock difference between the devices. Differences in the local time between computing devices can cause problems when the computing devices, or software running on the computing devices, need to make decisions that depend on an accurate time reference between the devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Technologies are provided for predicting clock offsets between computing devices (machines) based on network packets exchanged between the computing devices. For example, a forward series of timestamp points and a reverse series of timestamp points can be obtained for a plurality of network packets sent between two computing devices. A forward anchor series and reverse anchor series of timestamp points can be generated from the forward series and the reverse series. The anchor series contain a subset of the timestamp points from their respective series. Clock offset between the computing devices can be estimated using the forward anchor series and the reverse anchor series. Estimated clock offset can include predictions of future clock offset.

In some implementations, the estimated or predicted clock offset is used to determine the delay in network communication between computing devices. For example, once the clock offset is known, the actual delay in a particular communication (e.g., a network packet sent between two computing devices) can be calculated using the local timestamps of the two computing devices and the clock offset.

### BRIEF DESCRIPTION OF THE DRAWINGS

FIG. 1 is a diagram depicting a graph of example timestamp series data from two computing devices.

FIG. 2 is a diagram depicting a graph showing selection of timestamp points for a forward anchor series, including identification of a local minimum.

FIG. 3 is a diagram depicting a graph showing selection of timestamp points for a forward anchor series, including identification of a violation condition.

FIG. 4 is a diagram depicting a graph showing segment selection for predicting timestamp offset.

FIG. 5 is a diagram depicting an example method for estimating clock offset between computing devices.

FIG. 6 is a diagram depicting an example method for estimating clock offset between computing devices, including calculating an actual delay value.

FIG. 7 is a diagram of an example computing system in which some described embodiments can be implemented.

### DETAILED DESCRIPTION

Overview

As described herein, various technologies are provided for determining clock offsets between computing devices. Clock offsets between the computing devices are determined based on timestamp information associated with forward packets and reverse packets sent between the computing devices. For example, a forward series and a reverse series of timestamp points can be obtained from forward and reverse network packets. A forward anchor series and a reverse anchor series can be generated from the forward series and the reverse series. The clock offset between the computing devices can be estimated using the forward anchor series and the reverse anchor series.

Clock offsets can be determined between two (or more) computing devices in which one or both of the computing devices does not have access to a clock synchronization service. For example, the computing devices may be connected via a local or remote network, but not to the Internet. As another example, the computing devices may not have access to a clock synchronization service, such as the network time protocol (NTP) service. For example, two computing devices may be connected directly (e.g., via a wireless network protocol) in a remote desktop scenario or a media streaming scenario, but not have access to a clock synchronization service.

Clock synchronization between computing devices can be important in scenarios where accurate timing of events between computing devices is needed. For example, in a remote desktop scenario it may be important to know the clock offset between the computing devices. As another example, determining clock offset between computing devices can improve the performance and accuracy synchronization in audio-video streaming scenarios (e.g., where audio content and video content are coming from different devices). As another example, determining clock offset can improve the performance of network rate control (e.g., by allowing network delay to be accurately measured and used for controlling network communication rate).

Clock synchronization between computing devices (e.g., machines such as servers, desktops, laptops, tablets, smart phones, networking equipment, and/or other types of computing devices) is a very important concept for many networked applications with real- time, or near real-time, communication needs that require precise timing information across the network. For example, clock synchronization can be important in scenarios such as remote desktop operation, audio-video streaming or playback, etc. The communication is typically carried out by sending and receiving network packets. These packets may carry local timestamps of the sending and/or receiving computing devices, which the computing devices (or software running on the computing devices) can use for computing properties such as one-way delay, etc. Let ATₛ be the (local) timestamp of a packet sent from computing device A, and BTᵣ be the (local) timestamp of the same packet received on computing device B, from which the following equation is derived:

BTᵣ=ATₛ+delay+TAB (Equation 1)

Where delay (also called the actual delay) is the actual time it takes for the packet to travel from A to B, and TAB is the clock difference (also called clock offset) between A and B at the same point in time. Clearly, it is not possible to obtain the information of delay based on the local information of ATₛ and BTᵣ alone, unless TAB is also known.

TAB can be expressed as:

TAB(t)=TAB₀+C∫₀^{t}(BF(τ)−AF(τ))dτ (Equation 2)

Where TAB₀ is the initial clock offset (e.g., right after both machines have finished starting up). AF and BF are the frequencies of the clocks in machine A and B respectively, and C is a constant to scale the integration to the number of ticks for reading of the timestamps. The clock skew, defined as BF(t)−AF(t), is the frequency difference between the two clocks. Clock skew exists because the clock hardware in both machines may be different, and produce slightly different frequencies. The skew may also vary slowly in time, affected by many factors such as changes in the ambient temperature of the hardware clocks, changes of the locations of the machines, etc.

In some implementations, the estimation of TAB is done at the sender end, which means that any receiver side timestamp info such as BTᵣ needs to be sent back to the sender machine via a separate network packet. In the description herein, a packet sent from the sender to the receiver is called a forward packet, and a packet sent from the receiver back to the sender is called a reverse packet. The reverse packet usually happens right after the receiver receives the forward packet, and it can also include the receiver's own timestamp (e.g., BTₛ indicating when the reverse packet is sent from the receiver machine), which can provide further information for the sender machine to use in performing the various clock offset techniques described herein. However, in some implementations, estimation of TAB can be done at the receiver end, or at both ends.

There are a number of existing approaches for estimating clock offsets between different devices. Most of them make use of the timestamps of the exchanged packets, such as the timestamp when a packet is sent from a first device and the timestamp when the same packet is received at a second device. Some existing solutions use a median line fitting technique. Such solutions, however, provide a poor estimate of the slope of the trend when the data is highly variable. Other existing solutions use a linear regression algorithm. However, linear regression algorithms do not work well due to the nature of the delay measurements. Specifically, the linear regression algorithm works well when the distributions of the data are normal. The network delay measurements, however, rarely satisfy this condition. More importantly, such approaches, which are based on the analysis of the complete set of samples for an overall average clock skew and offset, do not provide good results when the clock skew is a slow varying function of time. Yet other existing solutions use an approach based on convex-hull analysis, but such solutions only provide an estimate of an average clock skew as a constant. Finally, a sliding-window based approach can also be applied to handle the slow varying nature of clock skew. However, a sliding-window approach may not work due to difficulty in choosing the window size as the pattern of clock skew varying in time is not predictable.

In some technologies described herein, a new approach is used to estimate TAB that makes use of a pair of piecewise linear functions as upper and lower bounds of TAB. These functions are constructed as upper and lower envelops of anchor points in the timestamp space of the exchanged packets between the machines A and B. The new approach is different from the convex-hull approach. For example, with the new approach, both convex and concave envelopes can be used to allow for time-varying clock skew. This new approach also does not require a sliding window approach to update TAB.

The new technologies described herein for estimating clock offset and determining actual delay can provide improvements handling of network traffic and in processing of network communications. For example, actual delay values can be used for more accurate and efficient rate control of network traffic.

Representation of Forward Packets and Reverse Packets

In the technologies described herein, timestamp information is exchanged between computing devices using forward network packets and reverse network packets. A forward network packet is sent from a first computing device to a second computing device, and a corresponding reverse network packet is sent in response from the second computing device back to the first computing device.

Consider a forward packet sent from machine A at local time ATₛ (e.g., using a timestamp function supported by machine A) and then received by machine B at local time BTᵣ (e.g., using a timestamp function supported by machine B). This timestamp data point can be represented graphically as a location on a two-dimensional coordinate system representing the time of machines A and B.

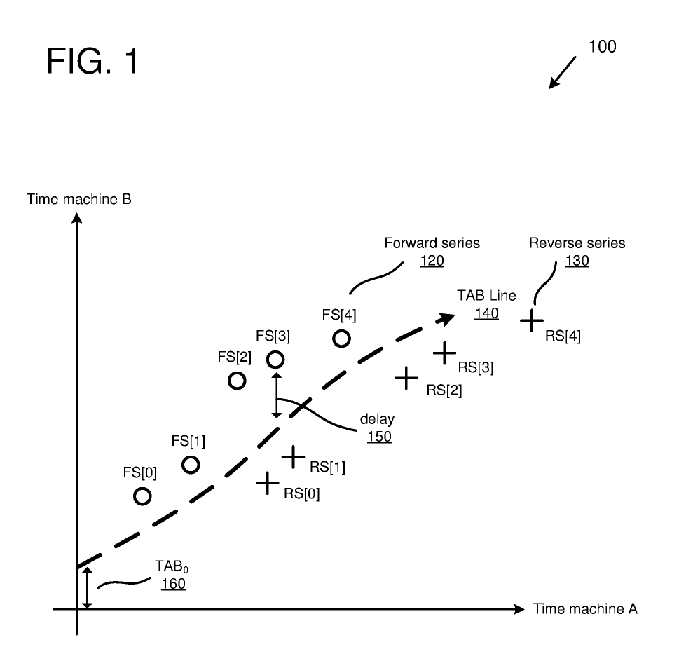

FIG. 1 is a diagram depicting a graph 100 of example timestamp data from two computing devices (machine A and machine B). In the graph, the local time of machine A is along the x-axis and the local time of machine B is along the y-axis. Initially, the local times of machines A and B differ by an amount represented by TAB₀ 160, which is the initial clock offset. If the clocks on machines A and B run at exactly the same rate (if there is no clock skew between them), then the TAB line would proceed from TAB₀ 160 as a straight 45-degree line. However, due to differences between the clocks in machines A and B, the TAB line will vary over time, as illustrated by the depicted TAB line 140.

It can be convenient to consider the TAB line defined as a map from time in machine A to time in machine B. It is easy to see that the TAB line is directly related to Equation 2 as Equation 2 can be expressed as the difference between the vertical coordinate and the horizontal coordinate on the TAB line.

In the graph 100, timestamp data is depicted for pairs of forward and reverse packets. The series of forward packets is labeled “FS” (for forward series) and represented as circles and the series of reverse packets is labeled “RS” (for reverse series) and represented as plus signs. For example, the first forward packet in the forward series is labeled “FS[0]” and the corresponding first reverse packet in the reverse series is labeled “RS[0]”. Each packet is plotted on the graph at its timestamp location. For a forward packet, its timestamp point or location is at x-y coordinates (ATₛ, BTᵣ). For a reverse packet, its timestamp point or location is at x-y coordinates (ATᵣ, BTₛ). The difference in time of machine A (along the x-axis) between a pair of corresponding packets (e.g., between FS[0] and RS[0]) is the round-trip time of the packet.

A number of observations can be made regarding the forward packets in graph 100. First, for a single timestamp point, the difference between the x-coordinate and the y-coordinate of the timestamp point is roughly the TAB, assuming the delay associated with the packet transmission and processing is small compared to the clock offset between machines A and B. Second, the trajectory of the forward series should be above the TAB line, and the distance to the TAB line is due to the delay for each packet in the forward series (e.g., delay 150). Third, if there is no clock skew, or if the clock skew is very small, then the clock offsets reported by each of the timestamp points would be roughly the same and the slope of the trajectory of each series would be roughly 45 degrees. However, as illustrated in the graph 100, the trajectory of each series does not appear to be a straight line. There are two main causes for this behavior. First, the delay contributing to BTᵣ and ATᵣ are positive values that vary from packet to packet. Second, the clock skew between machines A and B can vary over time.

A number of observations can be made regarding the reverse packets in graph 100. First, a given reverse packet has a vertical coordinate equal or slightly higher than that of its corresponding forward packet (BTᵣ<=BTₛ). This is because the send time of the reverse packet is equal to or greater than the receive time of the forward packet (machine B sends the reverse packet after the forward packet is received from machine A). Also, the horizontal coordinate of the reverse packet is greater than that of the forward packet (ATᵣ>=ATₛ). The difference between them (ATᵣ-ATₛ) is the round-trip time for the exchange of the pair of packets. Second, the delays of the reverse packets from B to A tend to push the trajectory of the reverse packets towards the right. In addition, the trajectory generally is not in a straight line because the delay in the reverse packets varies in time (as with the forward packets), and the clock skew between machines A and B can also vary in time.

As the graph 100 illustrates, previous solutions that assume the TAB line will be a straight line (such as the convex hull solution) do not work correctly in real-world environments where clock skew exists. For example, with the convex hull solution, a divergent point in a concaved region is assumed to be due to high delay and thus removed. However, in reality such a point can be due to the TAB curve changing over time.

Series of Packets and Condition of In Violation

In the technologies described herein, the determination and prediction of clock offsets involves using both the forward series and reverse series of packets. Because the TAB line varies over time, there may be portions of the TAB line that are concave and portions that are convex.

For example, the series of reverse packets can help differentiate the high delay contribution from concaveness of the TAB curve. As can be seen from FIG. 1, the two trajectories (the forward series and the reverse series) roughly form a narrow band with the TAB line somewhere in the middle. Neither trajectory may be completely concave nor convex throughout the entire range. But, a concave segment of one trajectory is typically accompanied by a convex segment from the other trajectory, and vice versa.

The order of timestamp points on a coordinate system for the forward series is defined as the order based on their horizontal coordinate (i.e., the sender side timestamp). Let FS (for Forward Series) be the ordered set of (ATₛ, BTᵣ) elements, each of which corresponds to a forward packet sent from A to B. Using an array notation to represent the series nature of the FS results in the following:

FS[i]<FS[j] for any pair of i and j where i<j, and 0≤i,j<RS. size (Equation 3)

Similarly, for the reverse series, RS (for Reverse Series) is the ordered set of (ATᵣ, BTₛ) elements, each of which corresponds to a reverse packet sent from B to A. Using an array notation to represent the series nature of the RS results in the following:

RS[i]<RS[j] for any pair of i and j where i<j and 0 ≤i,j<RS. size (Equation 4)

Any two elements FS[i] and FS[j] in the FS define a segment, denoted by Segment(FS[i], FS[j]), by connecting them via a straight line. The two elements FS[i] and FS[j] also define a line, denoted by Line(FS[i], FS[j]), in the two-dimensional coordinate system by extending the segment in both directions. The slope of the line is denoted by Slope(FS[i], FS[j]). In a similar way, any two elements RS[i] and RS[j] in the RS define a Segment(RS[i], RS[j]), and by extending the segment in both directions they define a Line(RS[i], RS[j]) with a slope Slope(RS[i], RS[j]).

Using these definitions of lines and segments, the concept of “in violation” is defined. Specifically, a Segment(FS[i], FS[j]) in FS is in violation if there exist a segment in the RS that intersects with the segment in the FS, and in addition a Line(FS[i],FS[j]) in the FS is in violation if there exist a segment in the RS that intersects with the line in the FS. The same concept of in violation is defined for lines and segments in the RS.

Forward Anchor Series and Reverse Anchor Series

In the technologies described herein, the forward series and the reverse series can be reduced to create a forward anchor series and a reverse anchor series. Over time, both the FS and RS grow with each new packet exchange to contain a large number of elements (an element is a timestamp point in either the forward series or the reverse series). In order to efficiently and accurately estimate TAB, a small subset of the FS and RS elements can be selected. The subset of the FS elements is denoted by FAS (forward anchor series) and the subset of the RS elements is denoted by RAS (reverse anchor series). The FAS is used to determine the upper bound for the TAB, and the RAS is used to determine the lower bound of the TAB.

The FAS is determined from the FS using the following procedure. The procedure begins with the newest element in the FS. Next, segments from the newest element to the elements already in FAS (from most recent backward) are evaluated in order (iterated) until the first condition of: a local minimum in the slope of the segment is found (this is the convex case) or until a segment is encountered that is in violation (at least one segment from the RAS is intersecting the segment; this is the concave case). During the iteration, elements in the FAS that are evaluated prior to finding the first of the two conditions are removed as these elements are considered related to high delay. In a specific implementation, the following algorithm is used to determine the FAS from the FS.

AddNewElementToFAS(newElement)

{

for(int i = FAS.size − 1; i >= 0; i−−)
{

Slope = slope(FAS[i], newElement);
if (Slope > lastSlope ∥ Segment(FAS[i], newElement ) is in
violation)

break;

lastSlope = Slope
RemoveFromFAS(i+1)

}
FSAPushToLast(newElement);

}

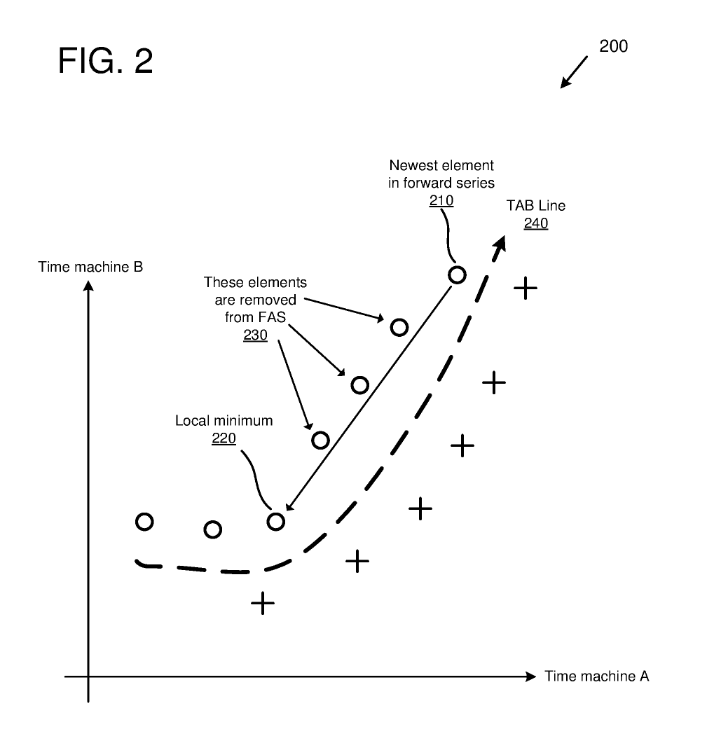

FIG. 2 is a diagram depicting a graph 200 showing selection of timestamp points for a forward anchor series. The graph 200 depicts timestamp point elements (forward and reverse) as well as a TAB line 240. The graph 200 illustrates application of the AddNewElementToFAS algorithm described above. Specifically, the algorithm is applied for the newest element 210 that has been added to the forward series. The algorithm iterates over the previous elements in the FAS until a local minimum or a segment in violation is located. In this example, a local minimum 220 is found first (this is the convex situation). As a result, the elements in the FAS between the newest element 210 and the local minimum 220 are removed from the FAS (as indicated at 230).

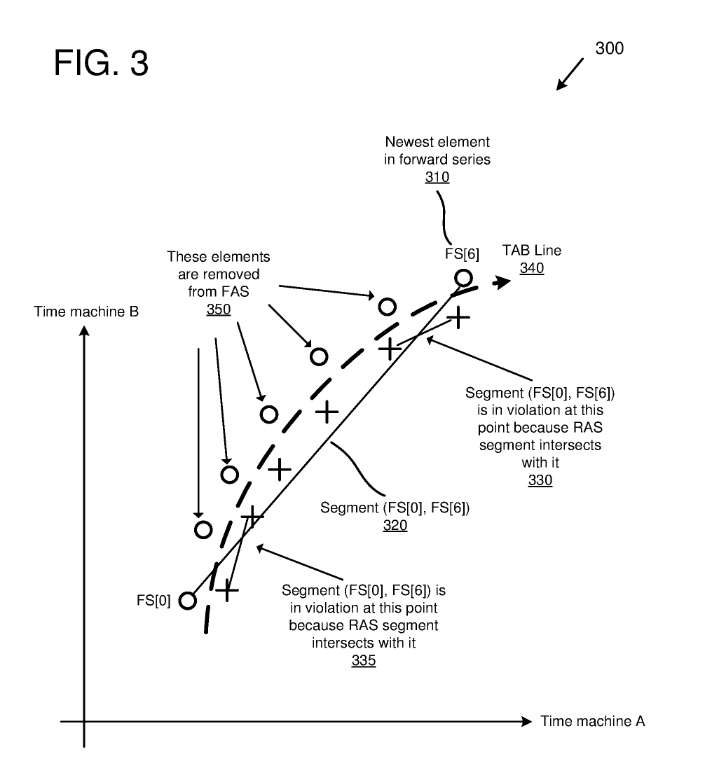

FIG. 3 is a diagram depicting a graph 300 showing selection of timestamp points for a forward anchor series. The graph 300 depicts timestamp point elements (forward and reverse) as well as a TAB line 340. The graph 300 illustrates application of the AddNewElementToFAS algorithm described above. Specifically, the algorithm is applied for the newest element 310 that has been added to the forward series. The algorithm iterates over the previous elements in the FAS until a local minimum or a segment in violation is located. In this example, a segment in violation is found first. Specifically, once the segment FS[6] to FS[0] 320 is reached, there are two RAS segments that intersect, identified at 330 and 335 (this is the concave situation). As a result, the elements in the FAS between the newest element 310 and element FS[0] are removed from the FAS (as indicated at 350).

The RAS is determined from the RS using essentially the same procedure described above for determining the FAS, except that the direction of the slope check and the line check are flipped. In a specific implementation, the following algorithm is used to determine the RAS from the RS.

AddNewElementToRAS (newElement)

{

for(int i = RAS.size − 1; i >= 0; i−−)
{

Slope = slope(RAS[i], newElement);
if(Slope < lastSlope ∥ Segment(RAS[i], newElement ) is in
violation)

break;

lastSlope = Slope
RemoveFromRAS(i+1)

}
RSAPushToLast(newElement);

}

Using the above algorithms, many timestamp data elements (e.g., associated with high delays) will be removed from the FS and RS to generate the FAS and RAS. For example, a given forward series or reverse series may contain thousands of elements or more. Using the above algorithms, this can be reduced to just a few elements (e.g., ten or less) in the forward anchor series or reverse anchor series. Furthermore, the FAS and RAS are still an ordered subseries according to Equations 3 and 4. Using this property, piecewise linear functions FAS(t) and RAS(t) can be defined by connecting segments Segment(FAS[i], FAS[i+1]) and Segment(RAS[i], RAS[i+1]) thru the entire respective series. FAS(t) and RAS(t) represent the upper and lower bounds of TAB, respectively.

Estimating TAB

In the technologies described herein, TAB is estimated from the forward anchor series and the reverse anchor series. For example, segments from the forward anchor series (forming the upper bound) and segments from the reverse anchor series (forming the lower bound) can be used to estimate TAB, including predicting TAB in the future.

In some implementations, TAB is determined to be in the middle between the upper bound and the lower bound. In other words, at any point in time, TAB(t)=(FAS(t)+RAS(t))/2. This implementation for estimating TAB produces good results for well established elements in the FAS and the RAS. However, it can produce less accurate results when predicting TAB into the future because the most recent elements in the FAS and the RAS have not yet gone through enough iterations to remove high delay elements (e.g., using the AddNewElementToFAS and AddNewElementToRAS algorithms)

In some implementations, future values for TAB are predicted based on the slope of segments of existing elements in the FAS and the RAS. For example, the slope of corresponding segments can be evaluated beginning with the most recent elements in the FAS and the RAS, and proceeding backward. The first corresponding slopes that do not result in an in violation condition can be selected and used to predict TAB by extending lines from the segments.

In some implementations, additional processing of the FAS and RAS elements is performed to skip the most recent elements in the FAS and RAS which may not yield accurate future predictions. Specifically, the slopes of the segments connecting the latest elements in the FAS and RAS may be far apart and therefore may not be good candidates for future prediction. In order to avoid this potential issue, a procedure is applied to walk back from the latest elements to find segments of adjacent elements in the FAS and RAS whose slopes are close to each other. In order or accurately evaluate the corresponding slopes in the FAS and RAS, the elements used for the segments should be co-located or close in time. In some implementations, in order for corresponding segments to be used in estimating TAB, the segments must overlap on the x-axis. In some implementations, the following algorithm, called a two-leg walking algorithm, is used to identify the segments used to predict TAB.

int i = FAS.size −2;
int j = RAS.size −2
while(TRUE)
{

SlopeUB = slope(FAS[i], FAS[i+1]);
SlopeLB = slope(RAS[j], RAS[j+1]);
Compute slope difference and track the minimum and break when
found
If(Line(FAS[i], FAS[i+1]) is in violation)

break;

If(Line(RAS[j], RAS[j+1]) is in violation)

break;

Compute weighted contribution to TAB (optional)
If(FAS[i] < RAS[j]) i−−; //step up one leg
else If(RAS[j] < FAS[i]) j−−; //step up the other leg
if(I == 0 or j == 0) //end condition

break;

}

In the while loop in the algorithm above, at any point FAS[i] and RAS [j] are considered co-located, the two segments defined by them via their corresponding slopes can be used to construct TAB at a future t as TAB(t)=y+slope (t−x)−t, where x and y are the coordinates of FAS[i] or RAS[j], and slope is either SlopeUB (slope upper bound) or SlopeLB (slope lower bound) correspondingly.

In some implementations, a weight is assigned for each pair of FAS[i] and RAS[j] for their contribution to TAB, and the aggregated contribution is obtained at the end. For example, the weight can be proportional to the inverse of the slope difference between corresponding segments, so that a pair of corresponding segments in the FAS and RAS with similar slopes will contribute more than a pair without similar slopes. A weight can also be inversely proportional to the distance between the corresponding segments. Then, a weighted average can be computed to determine the slopes to use for the prediction of TAB. In some implementations, all elements of the FAS and RAS are used in the weighted average computation. In some implementations, only some of the elements are used (e.g., by excluding the most recent elements and/or those that result in an in violation condition).

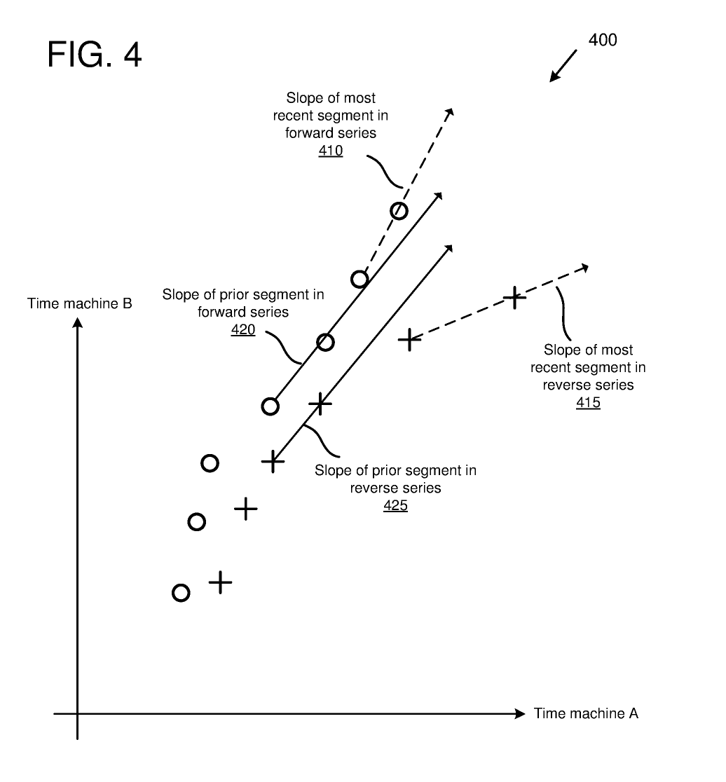

FIG. 4 is a diagram depicting a graph 400 showing segment selection for predicting timestamp offset. The graph 400 illustrates the problem that can occur if the most recent segment is used for the prediction, and how the two-leg walking algorithm can be applied to achieve a more accurate prediction. Specifically, if the most recent segment is used, the slopes may diverge significantly, as depicted by the slope 410 (from the most recent two elements in the forward series) and the slope 415 (from the most recent two elements in the reverse series. However, using the two-leg walking algorithm, the slopes of previous elements are visited until segments are identified with slopes that are close, as depicted by slopes 420 (for the forward series) and 425 (for the reverse series). In some implementations, the two-leg walking algorithm proceeds until segments with a similar slope are obtained (e.g., slopes within a small number of degrees of one another, such as within a pre-defined or user-configured threshold).

Example Methods for Determining Clock Offset Between Computing Devices

In the technologies described herein, methods can be provided for estimating clock offsets between computing devices. For example, a current and/or future clock offset estimate can be determined (e.g., represented as a predicted TAB line) using a forward series and a reverse series of timestamp point elements. The forward series and reverse series can be used to generate a forward anchor series and a reverse anchor series from which the clock offset can be estimated.

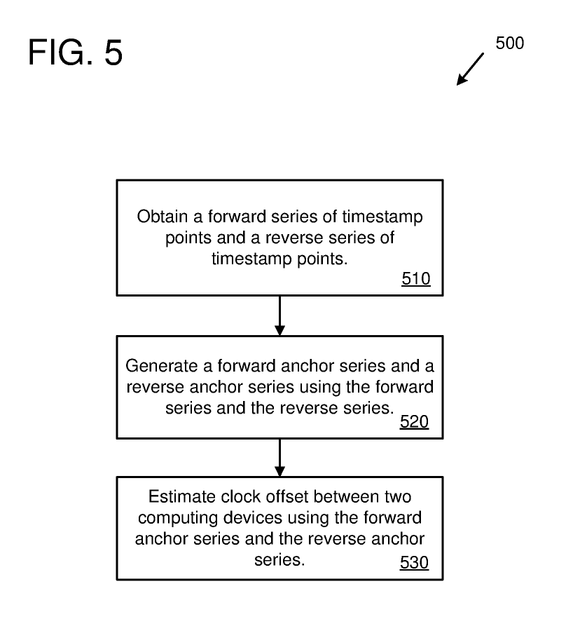

FIG. 5 is a flowchart of an example method 500 for determining the clock offset between two computing devices. At 510, a forward series (FS) of timestamp points (also called elements or timestamp elements) and a reverse series (RS) of timestamp points is obtained from a plurality of network packets sent between a first computing device and a second computing device.

At 520, a forward anchor series (FAS) and a reverse anchor series (FAS) of timestamp points is generated using the forward series and the reverse series. The forward anchor series contains a subset of timestamp points from the forward series and the reverse anchor series contains a subset of timestamp points from the reverse series.

At 530, a clock offset value is estimated between the two computing devices using the forward anchor series and the reverse anchor series. In some implementations, slopes of segments between timestamp points in the forward anchor series and the reverse anchor series are used to estimate the clock offset value (e.g., to determine a present and/or future clock offset value). The clock offset value can be determined for a particular point in time (e.g., as the midpoint between two lines formed by segments in the forward anchor series and the reverse anchor series) and/or as a continuous function (e.g., the midpoint can be represented as a predicted TAB line).

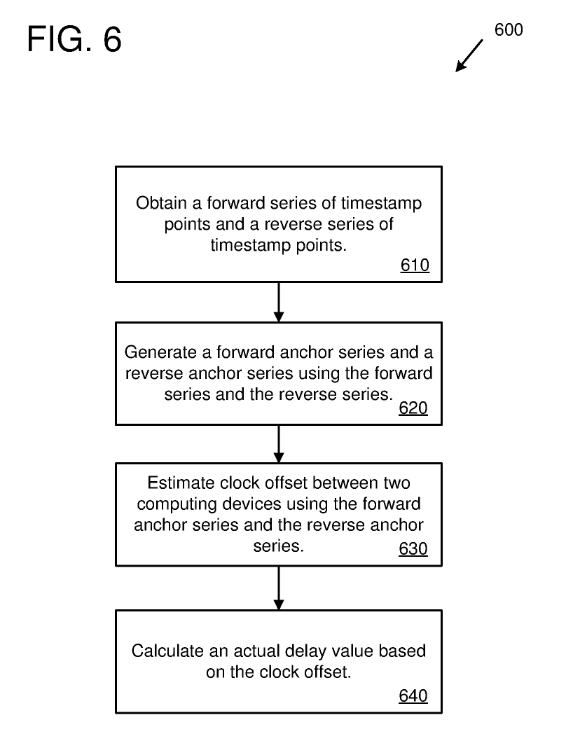

FIG. 6 is a flowchart of an example method 600 for estimating clock offset between computing devices, including calculating an actual delay value. At 610, a forward series (FS) of timestamp points (also called elements or timestamp elements) and a reverse series (RS) of timestamp points is obtained from a plurality of network packets sent between a first computing device and a second computing device.

At 620, a forward anchor series (FAS) and a reverse anchor series (FAS) of timestamp points is generated using the forward series and the reverse series. The forward anchor series contains a subset of timestamp points from the forward series and the reverse anchor series contains a subset of timestamp points from the reverse series.

At 630, clock offset is estimated between the two computing devices using the forward anchor series and the reverse anchor series. In some implementations, slopes of segments between timestamp points in the forward anchor series and the reverse anchor series are used to estimate the clock offset value (e.g., to determine a present and/or future clock offset value). The clock offset can be determined for a particular point in time (e.g., as the midpoint between two lines formed by segments in the forward anchor series and the reverse anchor series) and/or as a continuous function (e.g., the midpoint can be represented as a predicted TAB line).

At 640, an actual delay value is calculated based on the clock offset. The actual delay value is network delay for a network packet sent between the two computing devices. In some implementations, the actual delay value is calculated using Equation 1 (in which “delay” is the actual delay value).

Computing Systems

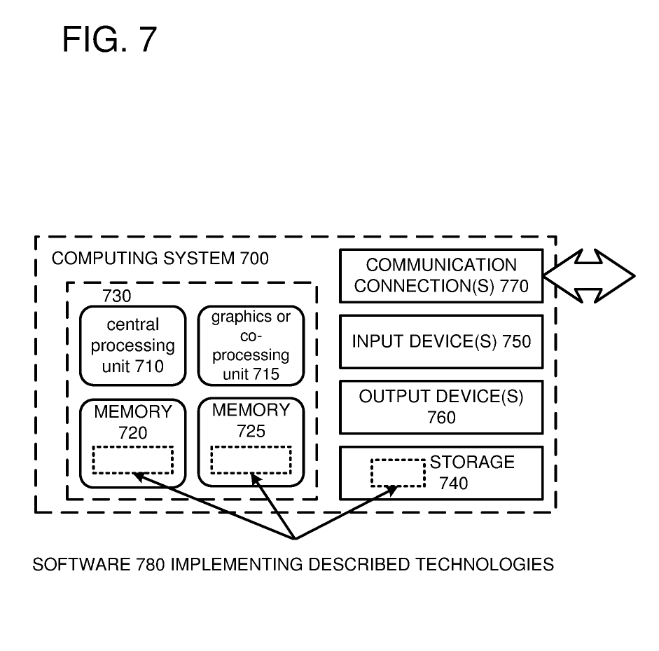

FIG. 7 depicts a generalized example of a suitable computing system 700 in which the described innovations may be implemented. The computing system 700 is not intended to suggest any limitation as to scope of use or functionality, as the innovations may be implemented in diverse general-purpose or special-purpose computing systems.

With reference to FIG. 7, the computing system 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s).

A computing system may have additional features. For example, the computing system 700 includes storage 740, one or more input devices 750, one or more output devices 760, and one or more communication connections 770. An interconnection mechanism (not shown) such as a bus, controller, or network interconnects the components of the computing system 700. Typically, operating system software (not shown) provides an operating environment for other software executing in the computing system 700, and coordinates activities of the components of the computing system 700.

The tangible storage 740 may be removable or non-removable, and includes magnetic disks, magnetic tapes or cassettes, CD-ROMs, DVDs, or any other medium which can be used to store information and which can be accessed within the computing system 700. The storage 740 stores instructions for the software 780 implementing one or more innovations described herein.

The input device(s) 750 may be a touch input device such as a keyboard, mouse, pen, or trackball, a voice input device, a scanning device, or another device that provides input to the computing system 700. For video encoding, the input device(s) 750 may be a camera, video card, TV tuner card, or similar device that accepts video input in analog or digital form, or a CD-ROM or CD-RW that reads video samples into the computing system 700. The output device(s) 760 may be a display, printer, speaker, CD-writer, or another device that provides output from the computing system 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 7, computer-readable storage media include memory 720 and 725, and storage 740. The term computer-readable storage media does not include signals and carrier waves. In addition, the term computer-readable storage media does not include communication connections, such as 770.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

What is claimed is:

1. A computing device comprising:
a processing unit; and
memory;
the processing unit executing computer instructions that perform operations to determine clock offsets between computing devices, the operations comprising:
obtaining a forward series of timestamp points and a reverse series of timestamp points from a plurality of network packets sent between the computing device and a second computing device;
generating a forward anchor series and a reverse anchor series using the forward series and the reverse series, wherein the forward anchor series is a subset of the timestamp points from the forward series, and wherein the reverse anchor series is a subset of the timestamp points from the reverse series; and
estimating a clock offset value between the computing device and the second computing device using the forward anchor series and the reverse anchor series.

2. The computing device of claim 1 wherein a timestamp point in the forward series is defined by two values:
local time of the computing device that a forward packet is sent from the computing device to the second computing device; and
local time of the second computing device that the forward packet is received by the second computing device.

3. The computing device of claim 2 wherein a timestamp point in the reverse series, that corresponds to the timestamp point in the forward series, is defined by two values:
local time of the computing device that a reverse packet is received from the second computing device in response to the forward packet; and
local time of the second computing device that the reverse packet is sent from the second computing device to the computing device in response to the forward packet.

4. The computing device of claim 1, wherein estimating the clock offset value comprises:
predicting a future clock offset value between the computing device and the second computing device based, at least in part, upon slopes of segments between timestamp points in the forward anchor series and slopes of segments between timestamp points in the reverse anchor series.

5. The computing device of claim 4 wherein predicting the future clock offset value comprises:
determining a first slope of a segment between adjacent timestamp points in the forward anchor series;
determining a second slope of a segment between adjacent timestamp points in the reverse anchor series; and
when a difference between the first slope and the second slope is less than a threshold amount, predicting the future clock offset value using the first slope and the second slope.

6. The computing device of claim 4 wherein predicting the future clock offset value comprises:
excluding one or more most recent timestamp points in the forward anchor series and the reverse anchor series from being used in predicting the future clock offset value.

7. The computing device of claim 4 wherein predicting the future clock offset value comprises:
for a plurality of corresponding segments in the forward anchor series and reverse anchor series:
calculating a weight for the corresponding segments that is an inverse of a difference in slopes between the corresponding segments, wherein the corresponding segments overlap along the x-axis;
calculating an upper bound slope and a lower bound slope based on weighted averages of the corresponding segments; and
using the upper bound slope and the lower bound slope to predict the future clock offset value.

8. The computing device of claim 1, the operations further comprising:
calculating an actual delay value between the computing device and the second computing device using the estimated clock offset value, comprising:
subtracting local time that a packet is sent from local time that the packet is received, and subtracting the clock offset value.

9. The computing device of claim 1 wherein generating the forward anchor series and the reverse anchor series comprises:
removing timestamp points from the forward series that represent high delay; and
removing timestamp points from the reverse series that represent high delay.

10. The computing device of claim 1 wherein generating the forward anchor series comprises:
evaluating segments from the newest timestamp point in the forward series backward until a first condition of:
a local minimum in slope of the segment is found; and
a segment is encountered that is in violation due to at least one segment from the reverse anchor series intersecting the segment.

11. The computing device of claim 1 wherein the computing device does not access a clock synchronization service.

12. A method, implemented by a computing device, for determining clock offsets between computing devices, the method comprising:
obtaining a forward series of timestamp points and a reverse series of timestamp points from a plurality of network packets sent between the computing device and a second computing device;
generating a forward anchor series and a reverse anchor series using the forward series and the reverse series, wherein the forward anchor series is a subset of the timestamp points from the forward series, and wherein the reverse anchor series is a subset of the timestamp points from the reverse series;
estimating clock offset between the computing device and the second computing device using the forward anchor series and the reverse anchor series; and
calculating an actual delay value between the computing device and the second computing device using the estimated clock offset, wherein the actual delay value is network delay for a network packet sent between the computing device and the second computing device.

13. The method of claim 12 wherein calculating the actual delay value comprises:
subtracting local time that a packet is sent from local time that the packet is received, and subtracting the clock offset.

14. The method of claim 12 wherein estimating the clock offset comprises:
predicting future clock offset between the computing device and the second computing device based, at least in part, upon slopes of segments between timestamp points in the forward anchor series and slopes of segments between timestamp points in the reverse anchor series.

15. The method of claim 14 wherein predicting the future clock offset comprises:
determining a first slope of a segment between adjacent timestamp points in the forward anchor series;
determining a second slope of a segment between adjacent timestamp points in the reverse anchor series; and
when a difference between the first slope and the second slope is less than a threshold amount, predicting the future clock offset using the first slope and the second slope.

16. The method of claim 14 wherein predicting the future clock offset comprises:
excluding one or more most recent timestamp points in the forward anchor series and the reverse anchor series from being used in predicting the future clock offset.

17. The method of claim 12 wherein generating the forward anchor series comprises:
evaluating segments from the newest timestamp point in the forward series backward until a first condition of:
a local minimum in slope of the segment is found; and
a segment is encountered that is in violation due to at least one segment from the reverse anchor series intersecting the segment.

18. A computer-readable storage medium storing computer-executable instructions for causing a computing device to perform operations determining clock offsets between computing devices, the operations comprising:
obtaining a forward series of timestamp points and a reverse series of timestamp points from a plurality of network packets sent between the computing device and a second computing device;
generating a forward anchor series and a reverse anchor series using the forward series and the reverse series, wherein the forward anchor series is a subset of the timestamp points from the forward series, and wherein the reverse anchor series is a subset of the timestamp points from the reverse series; and
estimating a clock offset value between the computing device and the second computing device using the forward anchor series and the reverse anchor series.

19. The computer-readable storage medium of claim 18 wherein estimating the clock offset value comprises:
predicting a future clock offset value between the computing device and the second computing device based, at least in part, upon slopes of segments between timestamp points in the forward anchor series and slopes of segments between timestamp points in the reverse anchor series.

20. The computer-readable storage medium of claim 18 the operations further comprising:
calculating an actual delay value between the computing device and the second computing device using the estimated clock offset value, comprising:
subtracting local time that a packet is sent from local time that the packet is received, and subtracting the clock offset value; and
using the calculated actual delay value to perform network rate control.
